(19) United States
(12) Patent Application Publication
(10) Pub. No.: US 2022/0018369 A1
(43) Pub. Date: Jan. 20, 2022

(54) SNAP-ON QUICK-RELEASE LOCK MECHANISM FOR UNMANNED AERIAL VEHICLE

(71) Applicant: SICHUAN AOSSCI TECHNOLOGY CO.,LTD., Chengdu (CN)

(72) Inventors: Liang GUO, Chengdu (CN); Xin YU, Chengdu (CN); Changyun WANG, Chengdu (CN); Jin WANG, Chengdu (CN); Xiaobo HE, Chengdu (CN); Chao WANG, Chengdu (CN)

(73) Assignee: SICHUAN AOSSCI TECHNOLOGY CO.,LTD., Chengdu (CN)

(21) Appl. No.: 17/379,058

(22) Filed: Jul. 19, 2021

(30) Foreign Application Priority Data
Jul. 17, 2020 (CN) 202021418102.2

(51) Int. Cl. F16B 2/18

(52) U.S. Cl. CPC F16B 2/18; B64C 39/024

(57) ABSTRACT

Disclosed is a snap-on quick-release lock mechanism for an unmanned aerial vehicle, including: a lock plate; a lock base; and a handle. The lock base is provided with a rotatable connecting member, the lock base is connected to the handle through the connecting member, and the handle is connected to the lock plate by snapping.

### CROSS-REFERENCE TO RELATED APPLICATIONS

This application claims priority to Chinese Patent Application No. 202021418102.2, filed on Jul. 17, 2020, the entire disclosure of which is incorporated herein by reference.

### TECHNICAL FIELD

The present disclosure belongs to the technical field of quick-release structures, and in particular relates to a snap-on quick-release lock mechanism for an unmanned aerial vehicle.

### BACKGROUND

Unmanned aerial vehicle (UAV) is a kind of unmanned aircraft mainly controlled by radio remote control or its own program. The UAV technology in China is developing rapidly. The UAV has the advantages of small size, low cost, being convenient for use, low environmental requirements, strong survivability, etc., and is widely used in various scenarios. Therefore, it is very important that the components can be quickly disassembled and assembled, and the connections between the components are firm. However, the UAV design process generally refers to the design of the UAV in service, and most of its components are connected by fixed connection, and it has an external lock or a built-in lock.

In actual use, the inventors found that the related arts have at least the following technical problems.

1. The components are disassembled and assembled in a fixed connection mode, which takes time and effort to assemble and disassemble.

2. When having an external quick-release mechanism, the aerodynamic resistance coefficient is relatively large when in use, a lot of space is taken up in the process of packaging, transportation and storage, and it is easily damaged. Once damaged, the repair is relatively cumbersome, and the repair cost is still very high.

3. When having a built-in quick release mechanism, it is not easy to check, repair and replace when there is a problem.

### SUMMARY

In order to overcome the above-mentioned shortcomings, the inventors of the present disclosure have been continuously reforming and innovating through long-term exploration attempts and many experiments and efforts, and proposed a quick-release lock mechanism for unmanned aerial vehicles, which can solve the problems of time-consuming and laborious assembly or disassembly of various components, not only occupying a large amount of space in the process of packaging, transportation and storage, but also easy to be damaged and difficult to inspect, repair and replace when problems occur.

In order to achieve the above objective, the present disclosure provides a snap-on quick-release lock mechanism for an unmanned aerial vehicle, including: a lock plate; a lock base; and a handle; the lock base is provided with a rotatable connecting member, the lock base is connected to the handle through the connecting member, and the handle is connected to the lock plate by snapping.

In an embodiment of the present disclosure, the handle is rotatably connected to the connecting member.

In an embodiment of the present disclosure, protrusions are provided on the handle, and grooves are defined on the lock plate.

In an embodiment of the present disclosure, the protrusions are symmetrically provided on both ends of the handle, and the grooves are symmetrically provided on both ends of the lock plate.

In an embodiment of the present disclosure, each of the grooves is provided at a dead point of a corresponding protrusion.

In an embodiment of the present disclosure, the connecting member includes a connecting rod and a pin shaft, the pin shaft includes a first pin shaft and a second pin shaft, one end of the connecting rod is connected to the lock base through the first pin shaft, and another end of the connecting rod is connected to the handle through the second pin shaft.

In an embodiment of the present disclosure, the connecting member further includes a threaded connecting sleeve, the threaded connecting sleeve is sleeved on the first pin shaft, one end of the connecting rod is connected to the threaded connecting sleeve through a thread, and another end of the connecting rod is connected to the second pin shaft.

In an embodiment of the present disclosure, a lock nut is tightly locked on the connecting rod behind the threaded connecting sleeve.

In an embodiment of the present disclosure, the lock base is also provided with a spring plate, one end of the spring plate is fixed on the lock base, and another end of the spring plate is abutted on the threaded connecting sleeve.

Compared with the related art, the technical solution of the present disclosure has the following advantages/beneficial effects:

1. A rotatable connecting member is provided on the lock base, and a rotatable handle is provided on another end of the connecting member. A buckle structure is provided on the handle and the lock plate. It only needs to rotate the handle far away from the lock plate upward, then press down the connecting member far away from the lock base, and then press down the handle to complete the lock. It needs to lift the handle, and then remove the connecting member to complete the unlocking. The operation is simple and does not take time and effort.

2. The lock plate and the lock base are installed on both sides of the quick-release interface during use, and are not completely built-in, which are very convenient to be checked when there is a problem. The mechanism is embedded in the quick-release interface to reduce the aerodynamic resistance caused by the installation of the lock during use. The structure is simple, the maintenance is simple, and the maintenance cost is low.

### BRIEF DESCRIPTION OF THE DRAWINGS

In order to explain the technical solutions of the embodiments of the present disclosure more clearly, the following will briefly introduce the drawings that need to be used in the embodiments. It should be understood that the following drawings only show some embodiments of the present disclosure, and therefore should not be regarded as limiting the scope. For those of ordinary skill in the art, without creative work, other related drawings can be obtained from these drawings.

FIG. 1 is a schematic structural diagram of a snap-on quick-release lock mechanism for an unmanned aerial vehicle of the present disclosure.

FIG. 2 is a schematic exploded structural view of Embodiment 1 of the present disclosure.

FIG. 3 is a schematic cross-sectional structural view of Embodiment 2 of the present disclosure.

FIG. 4 is a schematic exploded structural view of Embodiment 3 of the present disclosure.

### DETAILED DESCRIPTION OF THE EMBODIMENTS

In order to make the purpose, technical solutions and advantages of the present disclosure clearer, the technical solutions in the embodiments of the present disclosure will be described clearly and completely below. Obviously, the described embodiments are a part of the embodiments of the present disclosure, rather than all of the embodiments. Based on the embodiments in the present disclosure, all other embodiments obtained by those of ordinary skill in the art without creative work fall within the protection scope of the present disclosure. Therefore, the detailed description of the embodiments of the present disclosure provided below is not intended to limit the claimed scope of the present disclosure, but merely represents selected embodiments of the present disclosure.

It should be noted that similar reference numerals and letters indicate similar items in the following drawings. Therefore, once a certain item is defined in one drawing, it may not be further defined and explained in the subsequent drawings.

### Embodiment 1

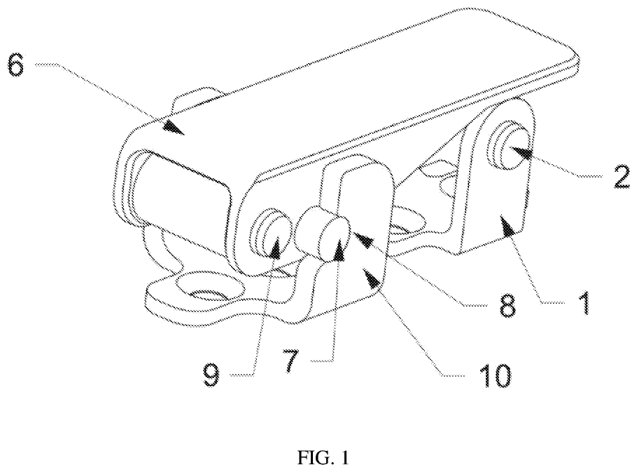

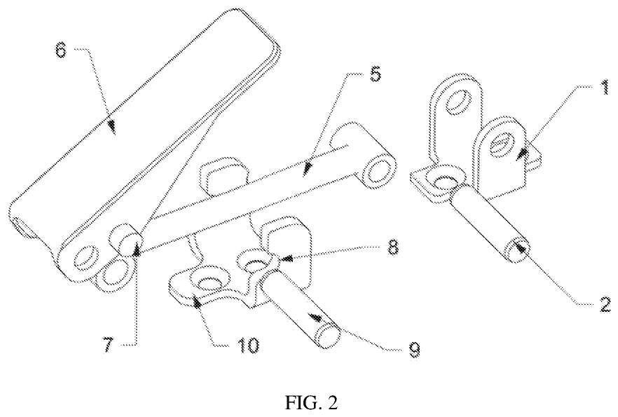

As shown in FIG. 1 and FIG. 2, a snap-on quick-release lock mechanism for an unmanned aerial vehicle includes: a lock base 1, a first pin shaft 2, a connecting rod 5, a handle 6, protrusions 7, grooves 8, a second pin shaft 9, and a lock plate 10. The lock base 1 is provided with a rotatable connecting member. The connecting member includes a pin shaft and the connecting rod 5. The pin shaft includes the first pin shaft 2 and the second pin shaft 9. The first pin shaft 2 is provided on the lock base 1. The connecting rod 5 is connected to the first pin shaft 2, that is to say, an end of the connecting rod 5 close to the lock base 1 can rotate around the first pin shaft 2. The connecting rod 5 is connected to the handle through the second pin shaft 9, that is to say, the handle can be rotated around the second pin shaft 9. The handle 6 is provided with the protrusions 7 which are cylindrical. The grooves 8 which are arc-shaped are provided on the lock plate 10. The protrusions 7 and the grooves 8 are matched with each other and can be buckled together. The handle 6 is connected to the lock plate 10 by snapping, that is, when the handle 6 is not locked, the lock plate and other parts are not fixed together. The protrusions 7 are symmetrically provided at both ends of the handle 6, the grooves 8 are symmetrically provided at both ends of the lock plate 10, and the grooves 8 are provided at dead points of the protrusions 7.

### Embodiment 2

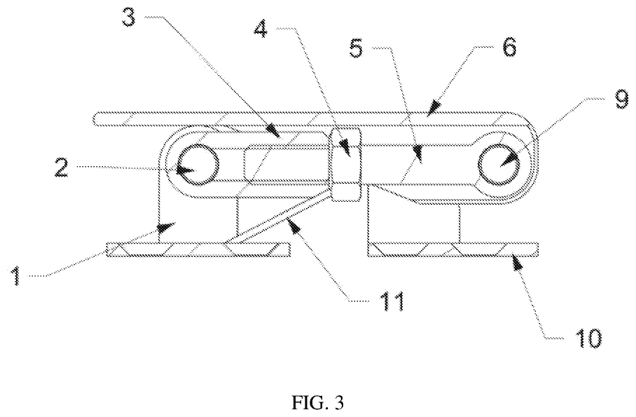

As shown in FIG. 1 and FIG. 3, a snap-on quick-release lock mechanism for an unmanned aerial vehicle includes: a lock base 1, a first pin shaft 2, a threaded connecting sleeve 3, a lock nut 4, a connecting rod 5, a handle 6, protrusions 7, grooves 8, a second pin shaft 9, a lock plate 10 and a spring plate 11. The lock base 1 is provided with a rotatable connecting member. The connecting member includes a pin shaft, the connecting rod 5 and the threaded connecting sleeve 3. The pin shaft includes the first pin shaft 2 and the second pin shaft 9, the first pin shaft 2 is provided on the lock base 1, and the threaded connecting sleeve 3 is sleeved on the first pin shaft 2. One end of the connecting rod 5 is connected to the threaded connecting sleeve 3 through a thread, and another end of the connecting rod 5 is connected to the second pin shaft 9. The connecting rod 5 behind the threaded connecting sleeve 3 is provided with the lock nut 4 and the lock nut 4 is tightly locked on the threaded connecting sleeve 3, the connecting rod 5 is connected to the handle 6 through the second pin shaft 9. The lock base 1 is also provided with the spring plate 11, one end of the spring plate 11 is fixed on the lock base 1, and another end of the spring plate 11 is abutted on the threaded connecting sleeve 3.

The handle 6 is provided with the protrusions 7 which are cylindrical. The grooves 8 which are arc-shaped are provided on the lock plate 10. The protrusions 7 and the grooves 8 are matched with each other and can be buckled together. The handle 6 is connected to the lock plate 10 by snapping, that is, when the handle 6 is not locked, the lock plate and other parts are not fixed together. The protrusions 7 are symmetrically provided at both ends of the handle 6, the grooves 8 are symmetrically provided at both ends of the lock plate 10, and the grooves 8 are provided at dead points of the protrusions 7.

### Embodiment 3

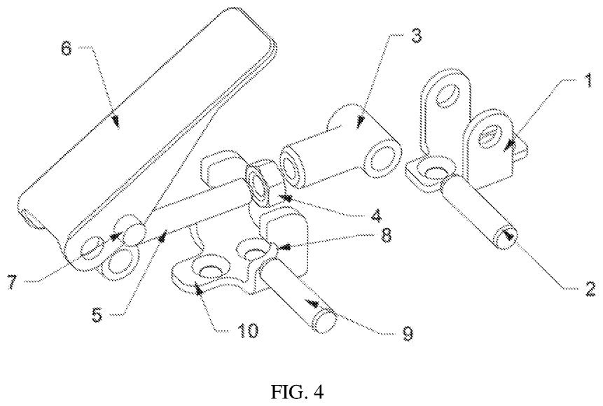

As shown in FIG. 1 and FIG. 4, a snap-on quick-release lock mechanism for an unmanned aerial vehicle includes: a lock base 1, a first pin shaft 2, a threaded connecting sleeve 3, a lock nut 4, a connecting rod 5, a handle 6, protrusions 7, grooves 8, a second pin shaft 9, and a lock plate 10. The lock base 1 is provided with a rotatable connecting member. The connecting member includes a pin shaft, the connecting rod 5 and the threaded connecting sleeve 3. The pin shaft includes the first pin shaft 2 and the second pin shaft 9, the first pin shaft 2 is provided on the lock base 1, and the threaded connecting sleeve 3 is sleeved on the first pin shaft 2. One end of the connecting rod 5 is connected to the threaded connecting sleeve 3 through a thread, and another end of the connecting rod 5 is connected to the second pin shaft 9. The connecting rod 5 behind the threaded connecting sleeve 3 is provided with the lock nut 4 which is tightly locked on the connecting rod 5, and the connecting rod 5 is connected to the handle 6 through the second pin shaft 9.

The handle 6 is provided with the protrusions 7 which are cylindrical. The grooves 8 which are arc-shaped are provided on the lock plate 10. The protrusions 7 and the grooves 8 are matched with each other and can be buckled together. The handle 6 is connected to the lock plate 10 by snapping, that is, when the handle 6 is not locked, the lock plate and other parts are not fixed together. The protrusions 7 are symmetrically provided at both ends of the handle 6, the grooves 8 are symmetrically provided at both ends of the lock plate 10, and the grooves 8 are provided at dead points of the protrusions 7.

The present disclosure is locked by a buckle method, and is provided with a dead point, which can prevent loosening. The so-called dead point is that in the plane linkage mechanism, if a rocker or a slider is a driver, when the other two moving parts are in the same straight line position, no matter how great the driving force is, the mechanism cannot be started. In other words, from Ft=F*cos α, when a pressure angle α=90°, the force or torque on a follower is zero, and the connecting rod cannot drive the follower to work, the position where the mechanism is located at this time is the dead point, also known as the stop point. The dead point of the present disclosure is provided on the lock plate where the connecting rod and the handle overlaps and form a straight line.

The lock nut can fix the threaded connecting sleeve and the connecting rod to prevent the threaded connecting sleeve and the connecting rod from loosening. The provided spring plate can prevent the snap-on quick-release lock from coming out due to vibration, and the spring plate can have a shock absorption effect. The mechanism is embedded in a quick-release interface, which can reduce the aerodynamic resistance caused by the installation of the lock. The mechanism is locked by a buckle method, which is simple and quick to operate and convenient for outfield use. Adjusting the position of the thread and the nut on the connecting rod can adjust the internal spacing of the mechanism to a certain extent and reduce the installation accuracy requirements.

When in use, the lock plate and the lock base are firstly installed on both sides of the component to be locked, then an end of the handle away from the second pin shaft is rotated upward, and then a side of the connecting rod away from the first pin shaft is pressed down, such that the connecting rod is as close as possible to an upper plane of the lock plate, the handle is rotated, and the protrusion rotates accordingly, then the protrusion is locked into the groove to complete the lock, and the spring plate tensions the mechanism to prevent the mechanism from leaving the dead point and unlocking due to vibration.

When unlocking, a tail of the handle is lifted up. During the rotation, the protrusion will slide out of the groove on the lock plate, and then a tail end of the connecting member is lifted up and out of the lock plate to complete the unlocking. The mechanism can be quickly locked in only two steps, and the operation is simple. After the lock plate and the lock base are installed and fixed, the tightness of the quick-release lock can be adjusted by adjusting the position of the thread and the nut of the intermediate connecting member, and the adjustability is strong.

In the description of the present disclosure, it should be understood that the orientation or positional relationship indicated by the terms “center”, “longitudinal”, “transverse”, “length”, “width”, “thickness”, “up”, “down”, “front”, “back”, “left”, “right”, “vertical”, “horizontal”, “top”, “bottom”, “inner”, “outer”, “clockwise”, “counterclockwise” etc. are based on the orientation or positional relationship shown in the drawings, and are only for the convenience of describing the present disclosure and simplifying the description, and do not indicate or imply that the device or element must have a specific orientation, be constructed and operated in a specific orientation, and therefore cannot be understood as a limitation of the present disclosure.

In this disclosure, unless expressly stipulated and defined, the terms “installed”, “connected”, “connecting”, “fixed” and other terms should be understood in a broad sense, for example, which can be fixed connection, detachable connection, or integrated; which can be a mechanical connection or an electrical connection; which can be a direct connection or an indirect connection through an intermediate medium, and which can be a connection between two components or an interaction relationship between two components. For those of ordinary skill in the art, the specific meanings of the above-mentioned terms in the present disclosure can be understood according to specific situations.

In this disclosure, unless expressly stipulated and defined, a first feature “above” or “under” a second feature may include that the first and second features directly contact, or the first and second features are not in direct contact but through another feature between them. Moreover, the second feature “on” or “above” the first feature includes the first feature being right above and not right above the second feature, or only that a level of the first feature is higher than that of the second feature. The first feature “below” or “under” the second feature include the first feature being right below and not right below the second feature, or only that the level of the first feature is lower than the second feature.

The above are only some embodiments of the present disclosure. It should be pointed out that the above-mentioned embodiments should not be regarded as limiting the present disclosure, and the protection scope of the present disclosure should be subject to the scope defined by the claims. For those of ordinary skill in the art, without departing from the spirit and scope of the present disclosure, several improvements and modifications can be made, and these improvements and modifications should also be regarded as the protection scope of the present disclosure.

What is claimed is:

1. A snap-on quick-release lock mechanism for an unmanned aerial vehicle, comprising:
a lock plate;
a lock base; and
a handle;
wherein the lock base is provided with a rotatable connecting member, the lock base is connected to the handle through the connecting member, and the handle is connected to the lock plate by snapping.

2. The snap-on quick-release lock mechanism for an unmanned aerial vehicle of claim 1, wherein the handle is rotatably connected to the connecting member.

3. The snap-on quick-release lock mechanism for an unmanned aerial vehicle of claim 1, wherein protrusions are provided on the handle, and grooves are defined on the lock plate.

4. The snap-on quick-release lock mechanism for an unmanned aerial vehicle of claim 3, wherein the protrusions are symmetrically provided on both ends of the handle, and the grooves are symmetrically provided on both ends of the lock plate.

5. The snap-on quick-release lock mechanism for an unmanned aerial vehicle of claim 4, wherein each of the grooves is provided at a dead point of a corresponding protrusion.

6. The snap-on quick-release lock mechanism for an unmanned aerial vehicle of claim 5, wherein the connecting member includes a connecting rod and a pin shaft, the pin shaft includes a first pin shaft and a second pin shaft, one end of the connecting rod is connected to the lock base through the first pin shaft, and another end of the connecting rod is connected to the handle through the second pin shaft.

7. The snap-on quick-release lock mechanism for an unmanned aerial vehicle of claim 6, wherein the connecting member further includes a threaded connecting sleeve, the threaded connecting sleeve is sleeved on the first pin shaft, one end of the connecting rod is connected to the threaded connecting sleeve through a thread, and another end of the connecting rod is connected to the second pin shaft.

8. The snap-on quick-release lock mechanism for an unmanned aerial vehicle of claim 7, wherein a lock nut is tightly locked on the connecting rod behind the threaded connecting sleeve.

9. The snap-on quick-release lock mechanism for an unmanned aerial vehicle of claim 8, wherein the lock base is also provided with a spring plate, one end of the spring plate is fixed on the lock base, and another end of the spring plate is abutted on the threaded connecting sleeve.
